(19) United States
(12) Patent Application Publication
(10) Pub. No.: US 2008/0272510 A1
(43) Pub. Date: Nov. 6, 2008

(54) Method and Apparatus for Directly Injecting Steam in an Expanded Plastic Material Mold

(76) Inventors: Dwight K. Buckle, Guelph (CA); Robert Dernovsek, Guelph (CA); David George Arthur Thomson, Kitchener (CA)

Correspondence Address: MAGNA INTERNATIONAL, INC., 337 MAGNA DRIVE, AURORA, ON, L4G-7K1, CA

(21) Appl. No.: 11/719,430

(22) PCT Filed: Jan. 27, 2006
(86) PCT No.: PCT/CA2006/000100

§ 371 Date: May 16, 2007

Related U.S. Application Data
(60) Provisional application No. 60/650,841, filed on Feb. 8, 2005.

(51) Int. Cl. B29C 44/02

(52) U.S. Cl. 264/50; 425/4 R

(57) ABSTRACT

A traditional steam chest molding apparatus for the manufacture of products from expanded plastic materials requires excessive amounts of steam to properly expand and fuse pellets of plastic together A molding apparatus is provided wherein a pair of complementary molds (100, 300) are provided with a steam manifold (110) to introduce steam into the mold cavity by way of steam lines (160, 162, 164, 166) The steam manifold (110) allows for direct injection of steam into the manifold and hence a reduction in the total steam required for a molding operation The amount of steam necessary for the production of a particular article is predetermined in dependence upon a geometry and a size of the article to be produced Thus if desired, the amount of steam provided to the mold cavity is measured prior to injection

### FIELD OF THE INVENTION

The present invention relates generally to the field of products from expanded plastic materials molded in a steam chest and to a steam chest molding apparatus and a method of forming expanded plastic materials therein.

### BACKGROUND OF THE INVENTION

A plurality of products made from particles or beads of expanded plastic materials are widely employed, for example as heat insulating materials, packaging materials, cushioning materials, or energy absorbers.

Energy absorbing elements are used in particular in the structure of motor vehicles in order to receive a large part of the kinetic energy of impact, and thus to increase the safety of occupants and pedestrians. Prior art applications are shock absorbers, side doors, and impact deflector elements which are used for the support of bumpers with respect to the supporting body structure.

Over the past few decades, energy absorption management has become an increasingly important part of the design and construction of modern transportation vehicles. Early on, it was recognized that vehicles designed with deformable front and/or rear structures provided greater safety to vehicle occupants in the case of a crash, due to the impact energy absorption by the structure as it deforms. It has become increasingly common to design vehicles, particularly automobiles, in this manner.

Current processes for making expanded plastic materials involve placing a mold inside a steam chest, filling the mold with plastic pellets and filling the steam chest with steam such that the steam enters the mold through vents in the mold, allowing the pellets to expand and fuse together.

The above-mentioned process of expanding plastic material in a steam chest mold does not make efficient use of the applied steam. Furthermore, in a steam chest, the mold components are exposed to an immoderate environment of extreme temperatures and humidity and hence the mold components endure a greater wear and tear.

Steam cost contribute to a large portion of the variable cost of expanded plastic materials, such as expanded polypropylene, manufacturing. Conventional molding tools for manufacturing expanded plastic materials must be encased in a steam chest of limited geometry. The steam chest limits the number of cavities, part orientation, and part geometry.

It is desirable to provide a more efficient mold design for making expanded plastic materials.

It is furthermore desirable to provide a more cost effective method of making expanded plastic materials.

### SUMMARY OF THE INVENTION

In accordance with the invention there is provided, a mold apparatus for forming an article from an expanded plastic material comprising a first mold portion and a complementary second mold portion for defining a mold cavity therebetween, said first mold portion comprising a fill plate having an inlet for providing the expandable plastic material to the mold cavity, and a manifold for providing steam to the mold cavity for expanding and fusing the expandable plastic material.

In accordance with another aspect of the invention the mold apparatus of the invention includes steam lines for providing the steam from the manifold to the mold cavity.

In accordance with yet another aspect of the invention, the mold apparatus further comprises an inlet for providing steam to the manifold.

In accordance with a further aspect of the invention, the mold apparatus comprises a measuring unit for providing a predetermined amount of steam to the mold cavity.

In accordance with another aspect of the invention, the first and second mold portion are made from a temperature resistant and humidity resistant material. Examples of suitable temperature and humidity resistant materials include aluminum and stainless steel.

In accordance with a further aspect of the invention, the manifold and the steam lines are made from copper.

In accordance with yet another aspect of the invention, examples of suitable expandable plastic materials include a styrene polymer, an acrylonitrile butadiene styrene (ABS) polymer, and a polyolefin. In accordance with one embodiment of the invention, the polyolefin is polypropylene.

In accordance with another embodiment of the invention, the manifold is integral with the first or second mold portion. La accordance with this embodiment of the invention, the steam lines are channels within the first or second mold portion, respectively.

In accordance with another aspect of the invention, the mold apparatus further comprises a plurality of vents for allowing the steam to enter the mold cavity. A number and location of the plurality of vents is determined in dependence upon a geometry and a size of the article to be produced.

In accordance with the invention, there is further provided, a process for making an article from an expanded plastic material comprising the steps of providing a first mold portion, providing a second mold portion, said second mold portion being complementary to the first mold portion, closing the first and the second mold portion with respect to one another for forming the mold cavity therebetween, filling the mold cavity with an expandable plastic material, providing steam to the mold cavity for expanding and bonding the expandable plastic material to form the molded article, the steam being provided to the mold cavity by means of a manifold to directly provide the steam to the mold cavity, opening the first and the second mold portion with respect to one another, and de-molding the molded article.

In accordance with another aspect of the invention, the process her comprises the step of measuring an amount of steam to provide a predetermined amount of steam to the mold cavity.

In accordance with yet another aspect of the invention, the process further comprises the step of determining an amount of steam required to expand and bond the expandable plastic material in dependence upon a geometry and a size of the article to be produced.

### BRIEF DESCRIPTION OF THE DRAWINGS

Exemplary embodiments of the invention will now be described in conjunction with the following drawings wherein like numerals represent like elements, and wherein:

FIG. 1 shows an isometric view of a cavity side of a mold apparatus in accordance with the invention;

FIG. 2 shows a front view of a cavity side of a mold apparatus in accordance with the invention;

FIG. 3 shows a top view of a core side of a mold apparatus in accordance with the invention; and

FIG. 4 shows a front view of a core side of a mold apparatus in accordance with the invention.

### DETAILED DESCRIPTION OF THE PREFERRED EMBODIMENTS

Current mold systems and processes of making expanded plastic materials require a mold cavity to be filled with expandable plastic beads, such as polypropylene beads, while the mold apparatus is completely encased in a steam chest. A plurality of vents trough the cavity and the core of the mold allow steam to penetrate the mold at each of the plurality of vent locations to activate the expandable plastic beads to expand and fuse together. Subsequently, the mold is showered with cool water which enters at each of the plurality of vent locations to cool the surface of the molded product while the product continues to exhaust a steam catalyst reacting at the fusion sites. Subsequently, the product is ejected from the mold.

A mold design in accordance with the invention removes the steam chest from the process and directs steam directly into the vent sites such that the steam is more concentrated and its volume reduced. This will drastically reduce the cost of heating steam, and hence fuel cost, as well as other incidental cost, such as purchase and maintenance of boilers and steam chests. Furthermore, the efficiency gain of reducing the amount of steam required will reduce cooling and processing time, reduce water consumption.

Thus, the present invention provides a method and molding apparatus to reduce the processing cost for making products of expanded plastic materials by reducing an amount of steam and cooling cycle times, as well as thermal energy requirements to produce steam.

This is accomplished by localizing the steam concentration to specific sites on the molded surface. By injecting steam into such predetermined sites, the steam chest, as used in the prior art, can be eliminated, and the steam can be introduced into the molding apparatus more efficiently through a steam manifold. An elimination of the steam chest can significantly reduce the amount of steam required to process a product and thereby reduce an amount of energy, such as heat/fuel, which is required to generate this steam. The reduced number of vents and steam can also reduce the steam exhaust and cooling times, as well as incidental cost of vent maintenance and/or replacement, and tool manufacturing cost. Furthermore, direct steam injection in accordance with the invention can also improve a surface appearance of a product molded by this process.

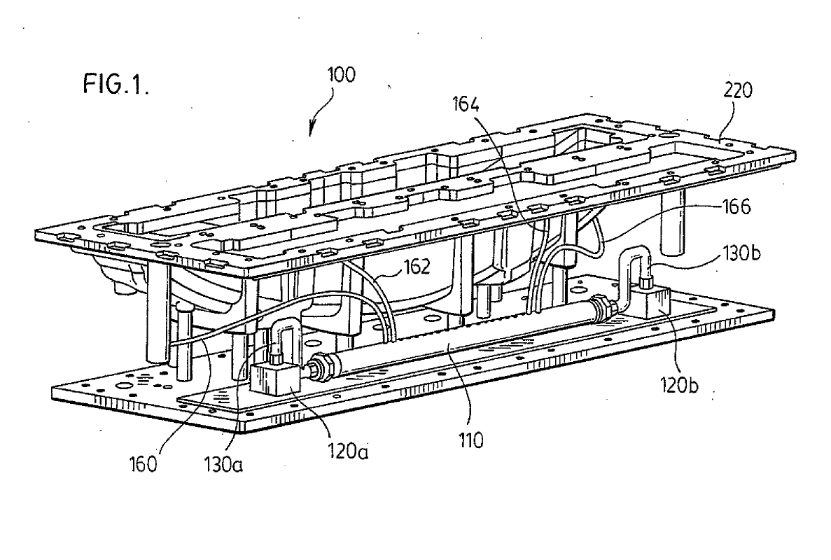

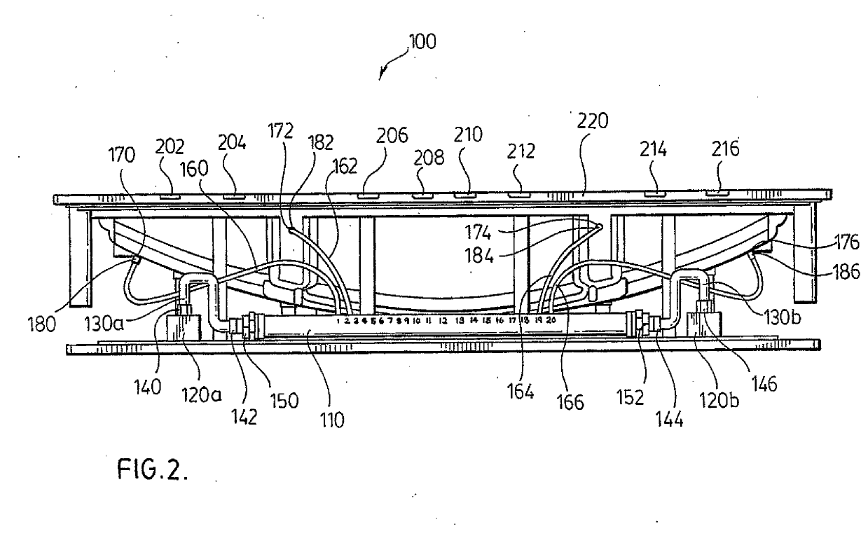

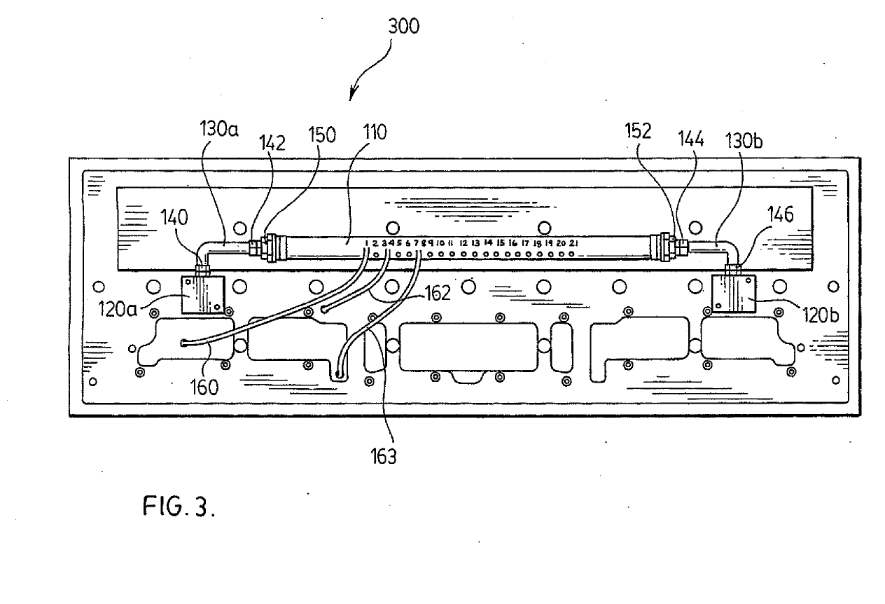

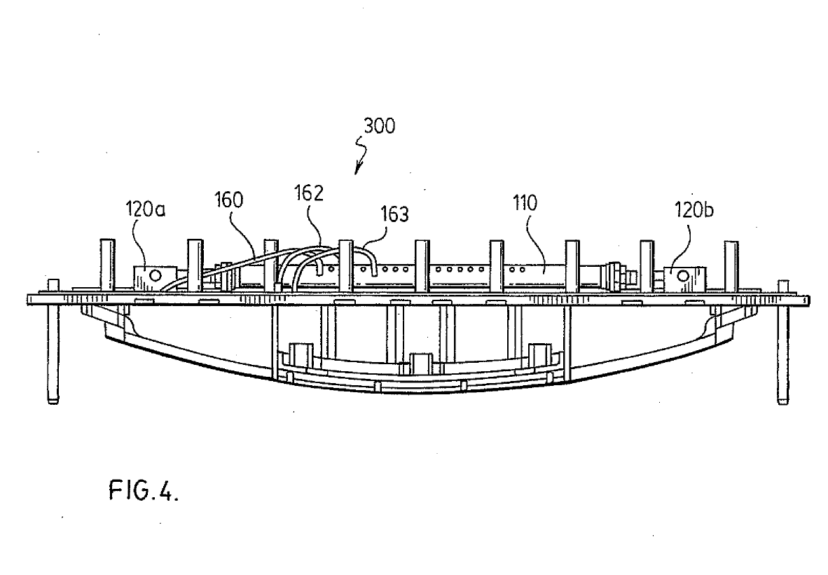

FIGS. 1 and 2 show an isometric view and a front view of a cavity side 100 of a mold apparatus in accordance with the invention, respectively, and FIGS. 3 and 4 show a top view and a front view of a core side 300 of a mold apparatus in accordance with the invention, respectively. As can be seen from these figures, the mold apparatus includes a manifold 110 to introduce steam into the tool via inlets 120a and 120b. The manifold is a female pipe and can be made from copper. As seen in FIGS. 1 and 2, the inlets 120a and 120b are connected to manifold 110 via 90 degree elbow fittings 130a and 130b, respectively, via compression fittings 140, 142, 144, 146 and reducer fittings 150, 152.

Manifold 110 includes a plurality of outlet holes as indicated by numbers 1 to 20 on the manifold to provide the steam from the manifold to a plurality of predetermined vents by means of steam lines 160, 162, 164 and 166. These steam lines are exemplary and more steam lines can be provided if desired. As can be seen from FIG. 2, in accordance with an embodiment of the instant invention, the steam lines are made from copper tubing and are fastened to vents 170, 172, 174, 176 of the mold apparatus by means of compression fittings 180, 182, 184, 186, respectively.

Thus, as seen from FIGS. 1 to 4, a mold apparatus is developed that can inject the steam directly into the mold so that the steam generation cost can be reduced as the volume of steam to fill the mold directly through the vents is lower than the volume of steam needed to fill a steam chest. Furthermore, the direct injection process, through a manifold system, can remove the need for a steam chest and open up the manufacturing window by reducing the amount of steam/heat that must be generated and exhausted. These options allow for the part to cool faster and thus run at lower cycle times, have better surface finish and dimensional stability, build moulds with more parts per platen, use conventional lifters and cylinders used in injection molding, reduce/eliminate the need for cooling water to cool the mold/part and offer a cleaner, quieter work environment.

The invention solves the problems with conventional steam chest molds by injecting a correct amount of steam into the part to expand and fuse the beads together and produce an acceptable product. The current process uses many more times the required amount of steam, since only a portion of the steam is being used to activate the EPP pellets, for example, while the rest is lost through exhaust and condensation in the steam chest. By injecting directly into the parts surface, the exact quantity of steam can be administered and controlled to efficiently achieve a robust manufacturing process.

In accordance with another embodiment of the invention, the manifold can also be provided in the tool itself so as to avoid the external provision of a manifold and steam lines. In this case, channels are provided in the mold, in place of the steam lines, to allow the steam to pass from the inlet via the manifold to the vent sites of the tool.

In accordance with an embodiment of the invention, the mold is made from aluminum.

In accordance with a further embodiment of the invention, the number of vents can be reduced, as in comparison to a steam chest mold, by allowing the steam to be provided to specific locations of the tool.

In accordance with yet a further embodiment of the invention, the number and location of the vents is determined in dependence upon a geometry and a size of the part to be produced.

In another embodiment of the invention, the steam provided to the various vent locations of the tool is metered.

In accordance with another aspect of the invention, a molding process is provided that uses directed steam through a manifold system. A tool in accordance with the invention including a cavity and a core is closed. An expandable plastic material, such as polypropylene or polystyrene, are injected into the tool via fill inlets 202, 204, 206, 208, 210, 212, 214, and 216 of fill plate 220. Subsequently, the fill inlets are closed and steam is directly injected into the tool via steam lines to allow the beads to expand and fuse together. Then, the tool is cooled, opened, and the final product is ejected from the mold.

Since the steam goes directly into the cavity of the tool, the tool will not heat up to the same extent as a tool in a steam chest, and hence a cool down time can be reduced and a cycle time can be increased.

A heat transfer from the steam to the part is instant and hence obviates the need to heat the entire tool. This in turn, can lead to a reduction in an injection time.

A particular application area for expanded plastic materials is the manufacture of energy management systems in bumpers of automotive vehicles. Commonly, such energy management systems are made from expanded polypropylene. In accordance with the invention, the cost for the process to mold expanded polypropylene (EPP) with direct steam injection can be reduced. This will aid the development of bumper impact systems and other products that use an EPP process where manufacturing economies are pursued to meet competitive pricing requirements. The economies can be realized through reductions in steam and cooling cycle times and thermal energy generation savings, as discussed hereinabove.

Advantageously, in accordance with the invention, the process of making expanded plastic materials by direct injection of steam is more environmentally friendly since it brings about a reduction of harmful emissions, noise pollution and mildew from the steam generation and the delivery process.

The above described embodiments of the invention are intended to be examples of the present invention and numerous modifications, variations, and adaptations may be made to the particular embodiments of the invention without departing from the spirit and scope of the invention, which is defined in the claims.

What is claimed is:

1. A mold apparatus for forming an article from an expanded plastic material comprising:
a first mold portion and a complementary second mold portion for defining a mold cavity therebetween, said first mold portion comprising a fill plate having an inlet for providing the expandable plastic material to the mold cavity, and
a manifold for providing steam to the mold cavity for expanding and fusing the expandable plastic material.

2. The mold apparatus as defined in claim 1 further comprising steam lines for providing the steam from the manifold to the mold cavity.

3. The mold apparatus as defined in claim 1 further comprising an inlet for providing steam to the manifold.

4. The mold apparatus as defined in claim 1 wherein the first and second mold portion are made from a temperature resistant and humidity resistant material.

5. The mold apparatus as defined in claim 4 wherein the temperature resistant and humidity resistant material is one of aluminum and stainless steel.

6. The mold apparatus as defined in claim 1 wherein the manifold and the steam lines are made from copper.

7. The mold apparatus as defined in claim 1 wherein the expandable plastic material is one of a styrene polymer, an acrylonitrile butadiene styrene (ABS) polymer, and a polyolefin.

8. The mold apparatus as defined in claim 1 wherein the manifold is integral with one of the first and second mold portion.

9. The mold apparatus as defined in claim 8 wherein the steam lines are channels within one of the first and second mold portion, respectively.

10. The mold apparatus as defined in claim 1 further comprising a measuring unit for providing a predetermined amount of steam to the mold cavity.

11. The mold apparatus as defined in claim 1 further comprising a plurality of vents for allowing the steam to enter the mold cavity.

12. The mold apparatus as defined in claim 11 wherein a number and location of the plurality of vents is determined in dependence upon a geometry and a size of the article to be produced.

13. A process for making an article from an expanded plastic material comprising the following steps:
providing a first mold portion;
providing a second mold portion, said second mold portion being complementary to the first mold portion;
closing the first and the second mold portion with respect to one another for forming the mold cavity therebetween;
filling the mold cavity with an expandable plastic material;
providing steam to the mold cavity for expanding and bonding the expandable plastic material to form the molded article, the steam being provided to the mold cavity by means of a manifold to directly provide the steam to the mold cavity;
opening the first and the second mold portion with respect to one another; and
de-molding the molded article.

14. The process as defined in claim 13 further comprising the step of measuring an amount of steam to provide a predetermined amount of steam to the mold cavity.

15. The process as defined in claim 13 further comprising the step of determining an amount of steam required to expand and bond the expandable plastic material in dependence upon a geometry and a size of the article to be produced.

16. The process as defined in claim 13 wherein the expandable plastic material is one of a styrene polymer, an acrylonitrile butadiene styrene (ABS) polymer, and a polyolefin.

17. The process as defined in claim 16 wherein the polyolefin is polypropylene.
